(19) United States
(12) Patent Application Publication
(10) Pub. No.: US 2025/0210333 A1
(43) Pub. Date: Jun. 26, 2025

(54) APPARATUS AND METHOD FOR MASS SPECTROMETRY USING NANOSTRUCTURE

(71) Applicant: KOREA INSTITUTE OF SCIENCE AND TECHNOLOGY, Seoul (KR)

(72) Inventors: Chulki KIM, Seoul (KR); Sang Wook HAN, Seoul (KR); Seungwoo JEON, Seoul (KR); Donggeun LEE, Seoul (KR); Hojoong JUNG, Seoul (KR); Dongyeon KANG, Seoul (KR)

(73) Assignee: KOREA INSTITUTE OF SCIENCE AND TECHNOLOGY, Seoul (KR)

(21) Appl. No.: 18/980,070

(22) Filed: Dec. 13, 2024

(30) Foreign Application Priority Data
Dec. 21, 2023 (KR) 10-2023-0188058

(51) Int. Cl. H01J 49/00

(52) U.S. Cl. CPC H01J 49/0018; H01J 49/0031

(57) ABSTRACT

Disclosed herein is an apparatus and method for mass spectrometry using a nanostructure that enables measuring mass of an analyte in room temperature. The apparatus may include: a chamber providing a space in which mass spectrometry is performed; an analyte input unit configured to input an analyte into the chamber; a substrate disposed inside the chamber and having at least one nanostructure formed thereon, to which the analyte input by the analyte input unit is adsorbed; an electron beam generator configured to irradiate the nanostructure with an electron beam; a secondary electron detection unit configured to detect a secondary electron signal emitted by an interaction of the electron beam with the nanostructure; and a mass measurement unit configured to identify a vibrational state of the nanostructure and measure a mass of the nanostructure through frequency analysis of the detected secondary electron signal.

### CROSS REFERENCE TO RELATED APPLICATIONS

The present application claims the benefit under 35 USC 119 (a) of Korean Patent Application No. 10-2023-0188058 filed on Dec. 21, 2023, in the Korean Intellectual Property Office, the entire disclosure of which is incorporated herein by reference for all purposes.

### BACKGROUND OF THE INVENTION

### Field of the Invention

The present invention relates to an apparatus and method for mass spectrometry using a nanostructure, and more particularly to an apparatus and method for mass spectrometry using a nanostructure that enables mass of an analyte to be measured at room temperature.

The present invention was conducted with the support of the National Research and Development Project of the Republic of Korea (Project Numbers: 1711196507, 1711196533, 1711195659, and 1711197995).

### Description of the Related Art

Proteomics is a discipline that identifies proteins, analyzes their characteristics, and obtains comprehensive quantitative information on proteins with regard to a proteome that is expressed by genetic information, and is primarily focused on post-transcriptional modification of the proteome, protein identification, and quantification techniques.

In proteomics, mass spectrometry is a technology that is essentially required to identify proteins and serves a vital role in proteomic assays as it provides structural and quantitative information on dynamically changing proteins, including modified proteins.

Among mass spectrometers for proteomic analysis, the matrix-assisted laser desorption ionization-time of flight (MALDI-TOF) mass spectrometer is an equipment that ionizes the components of an analyte using the MALDI ionization method and measure the time it takes for the generated ions to reach a detector (Time Of Flight) to analyze the molecular weight of the ions. After mixing the analyte with a matrix to create a crystal, the equipment irradiates the crystal with a laser to ionize the analyte. The equipment measures the time of arrival of the ions to determine the mass of the analyte on the basis of the principle in which the lighter ions reach the detector and are detected first and the heavier ions later among the ionized analytes.

The measurement range of molecular weight using the MALDI-TOF mass spectrometer is 1 kDa to 500 kDa, and proteins are identified using the peptide mass fingerprinting (PMF) technique.

However, the measurement range of molecular weights in the MALDI-TOF mass spectrometer is limited to 1 kDa to 500 kDa, and as the size of the analyte increases, the number of cases of mass for the cleaved material increases, which leads to a problem of not being able to accurately specify the mass.

Meanwhile, a mass spectrometer using a quartz crystal microbalance (QCM) measures changes in mass per unit area by measuring changes in resonant frequency in response to changes in the mass of an analyte bound to a surface of a quartz crystal oscillator using the piezoelectric properties that a quartz crystal has.

The mass spectrometer using the quartz crystal microbalance (QCM) has a minimum measurable mass of approximately 1 μg/cm² or more.

Meanwhile, a mass spectrometer using a nanoelectromechanical system (NEMS) device with a silicon (Si) nanostructure or a carbon nanotube (CNT) nanostructure adsorbs an analyte to the nanostructure and measures a change in resonant frequency in response to a change in the mass of the adsorbed analyte to measure the mass.

The mass spectrometer using the NEMS device has a problem in that the mechanical properties of the nanostructure provided in the NEMS device become better at lower temperatures, which requires the NEMS device to be kept in a lower temperature state, and the measured value varies depending on the position of the analyte adsorbed in the nanostructure, making it difficult to measure the mass accurately.

### Documents of Related Art

(Patent Document 1) US 2014-0156224 (Published on Jun. 5, 2014)

### SUMMARY OF THE INVENTION

The present invention is directed to solving the conventional problems as described above, and an object of the present invention is to provide an apparatus and method for mass spectrometry using a nanostructure that enables mass of an analyte to be measured at room temperature.

Another object of the present invention is to provide an apparatus and method for mass spectrometry using a nanostructure that enables accurate mass measurement regardless of an adsorption position of an analyte.

There is provided an apparatus for mass spectrometry using a nanostructure, according to the present invention, in order to achieve the aforementioned object. The apparatus may include: a chamber providing a space in which mass spectrometry is performed; an analyte input unit configured to input an analyte into the chamber; a substrate disposed inside the chamber and having at least one nanostructure formed thereon, to which the analyte input by the analyte input unit is adsorbed; an electron beam generator configured to irradiate the nanostructure with an electron beam; a secondary electron detection unit configured to detect a secondary electron signal emitted by an interaction of the electron beam with the nanostructure; and a mass measurement unit configured to identify a vibrational state of the nanostructure and measure a mass of the nanostructure through frequency analysis of the detected secondary electron signal.

In addition, in the apparatus for mass spectrometry using a nanostructure, the nanostructure formed in the substrate may be formed in a tapered structure that tapers downward.

In addition, in the apparatus for mass spectrometry using a nanostructure, the nanostructure formed in the substrate may be implemented in a diamond material.

In addition, there is provided a method of mass spectrometry using a nanostructure, according to the present invention, in order to achieve the aforementioned object. The method may include: inputting an analyte into a chamber; setting an electron beam irradiation area for a nanostructure to which the input analyte is adsorbed; irradiating the set electron beam irradiation area with an electron beam; detecting a secondary electron signal emitted by an interaction of the electron beam with the nanostructure; identifying a vibrational state of the nanostructure through frequency analysis of the detected secondary electron signal; and recording frequency information on the detected secondary electron signal and the electron beam irradiation area when the vibrational state of the nanostructure is identified as a result of the identification, and measuring mass of the analyte on the basis of a frequency analysis result.

In addition, in the method of mass spectrometry using a nanostructure, according to the present invention, the method may further include: resetting an electron beam irradiation area, when the vibrational state of the nanostructure is not identified as a result of the identification, then proceeding to the step of irradiation with an electron beam, irradiating the reset electron beam irradiation area with an electron beam, and repeating the subsequent steps.

In addition, there is provided a method of mass spectrometry using a nanostructure, according to the present invention, in order to achieve the aforementioned object. The method may include: inputting an analyte into a chamber; setting nanostructures to be measured from a nanostructure array in which the inputted analyte is adsorbed; setting an electron beam irradiation area for one nanostructure of the set nanostructures to be measured; irradiating the set electron beam irradiation area with an electron beam; detecting a secondary electron signal emitted by an interaction of the electron beam with the nanostructure; identifying a vibrational state of the nanostructure through frequency analysis of the detected secondary electron signal; recording frequency information of the detected secondary electron signal and an electron beam irradiation area, when the vibrational state of the nanostructure is identified as a result of the identification, and measuring mass of the analyte adsorbed to the nanostructure on the basis of a frequency analysis result; determining whether the nanostructure is a final nanostructure among the nanostructures to be measured; and terminating the mass spectrometry when the nanostructure is the final nanostructure as a result of the determination, setting an electron beam irradiation area for a next nanostructure when the nanostructure is not the final nanostructure, then proceeding to the step of irradiation with an electron beam, irradiating the set electron beam irradiation area with an electron beam, and repeating the subsequent steps.

In addition, in the method of mass spectrometry using a nanostructure, according to the present invention, the method may further include: resetting an electron beam irradiation area, when the vibrational state of the nanostructure is not identified as a result of the identification, then proceeding to the step of irradiation with an electron beam, irradiating the reset electron beam irradiation area with an electron beam, and repeating the subsequent steps.

Other specific details of the embodiments are included in the “detailed description of the invention” and the “drawings” attached hereto.

Advantages and features of the present invention and methods of achieving the advantages and features will be clear with reference to various embodiments described in detail below together with the accompanying drawings.

However, it should be understood that the present invention are not limited to the configuration of each of the embodiments disclosed below, but may also be implemented in a variety of other forms, and that each of the embodiments disclosed herein is provided only to make the disclosure of the present invention complete and to fully inform those skilled in the art to which the present invention belong of the scope of the present invention, and that the present invention are only defined by the scope of each claim of the appended claims.

According to the present invention, it is possible to measure mass of an analyte at room temperature using a nanostructure of diamond material formed in a tapered structure that tapers downward.

In addition, it is possible to achieve an accurate mass measurement regardless of an adsorption position of an analyte.

### BRIEF DESCRIPTION OF THE DRAWINGS

FIG. 1 is a view schematically illustrating the configuration of an apparatus for mass spectrometry using a nanostructure, according to an embodiment of the present invention.

FIG. 2 is a view exemplarily illustrating the geometry of a nanostructure applicable to the present invention.

FIG. 3 is a processing view for describing a method of mass spectrometry using a nanostructure according to an embodiment of the present invention.

FIG. 4 is a processing view for describing a method of mass spectrometry using a nanostructure according to another embodiment of the present invention.

FIG. 5 is a view exemplarily illustrating a nanostructure applicable to the present invention.

FIG. 6 is a view exemplarily illustrating a secondary electron signal detected, according to the present invention.

FIG. 7 is a view exemplarily illustrating a frequency spectrum obtained by Fourier transforming a secondary electron signal detected, according to the present invention.

FIG. 8 is a view exemplarily illustrating an experimental result of performing a mass measurement, according to the present invention.

FIG. 9 is a view exemplarily illustrating mass of a T5 phage among bacteriophages.

FIG. 10 is a view exemplarily illustrating a demonstrative graph to show how Δf is determined in the present invention.

FIG. 11 is a view exemplarily illustrating a spring constant (elastic modulus) for a nanostructure of a diamond material applicable to the present invention.

FIG. 12 is a view exemplarily illustrating a result of measuring mass of a protein molecule according to the present invention.

FIG. 13 is a view exemplarily illustrating measurement frequencies depending on a position of an analyte adsorbed in a nanostructure of a diamond material applicable to the present invention.

FIG. 14 is a view exemplarily illustrating a performance comparison result of the present invention and the prior arts.

FIGS. 15A to 15C are a view exemplarily illustrating a case in which mass spectrometry is performed by sequentially irradiating a plurality of nanostructures with an electron beam, according to the present invention.

### DETAILED DESCRIPTION OF THE INVENTION

It should be understood that before describing the present invention in detail, the terms and words used in the present specification are not to be interpreted unconditionally and without limitation in the general or dictionary meaning, and that the inventor of the present invention may appropriately define and use the concepts of various terms to best describe his/her own invention, and further that these terms and words are to be interpreted in a meaning and concept consistent with the technical spirit of the present invention.

That is, it should be understood that the terms used in the present specification are used only to describe preferred embodiments of the present invention and are not intended to specifically limit the content of the present invention, and that these terms are terms defined in consideration of the various possibilities of the present invention.

In addition, in the present specification, it should be understood that singular expressions may include plural expressions unless the context clearly indicates a different meaning, and similarly, the plural expressions may have a singular meaning.

Throughout the present specification, where a constituent element is described as “comprising/including” another element, which, unless specifically stated to the contrary, may mean to include any other constituent element and not to exclude any other constituent element.

Further, when a constituent element is described as “existing within, or being installed in connection with,” another constituent element, it should be understood that the constituent element may be directly connected to, installed in contact with, or installed spaced a certain distance apart from another constituent element, and that in case of being installed spaced a certain distance apart, there may be a third constituent element or means for fixing or connecting the constituent element to another constituent element, and the description of the third constituent element or means may be omitted.

In contrast, when a constituent element is described as being “directly connected” or “directly accessed” to another constituent element, it should be understood that there is no third constituent element or means.

Similarly, other expressions that describe the relationship between respective constituent elements, such as “between” and “directly between”, or “adjacent to” and “directly adjacent to”, should be interpreted in the same manner.

In addition, it should be understood that when the terms “one surface,” “the other surface,” “one side,” “the other side,” “first,” “second,” and the like, are used in the present specification, they are used to refer to one constituent element so that this one constituent element can be clearly distinguished from other constituent elements, and that the meaning of the corresponding constituent element is not limited by such terms.

In addition, when the terms relating to a position, such as “top,” “bottom,” “left,” “right,” and the like, are used in the present specification, it should be understood that they refer to a relative position in the corresponding drawing with respect to the corresponding constituent element, and should not be understood that the terms relating to a position refer to an absolute position, unless the absolute position is specified with respect to the constituent element.

Further, it should be understood that in the specification of the present invention, the terms ““unit,”” “device,” “module,” “apparatus,” and the like, when used, mean a unit capable of performing one or more functions or operations, which may be implemented in hardware or software, or a combination of hardware and software.

In addition, in specifying the reference numeral for each constituent element in each drawing, the present specification is intended to indicate that the same constituent element has the same reference numeral even though it is illustrated in different drawings, i.e., the same reference numeral throughout the specification refers to the same constituent element.

In the drawings accompanying the present specification, the size, position, coupling relationships, etc. of each of the constituent elements constituting the present invention may be exaggerated, reduced, or omitted in some respects in order to convey the spirit of the present invention with sufficient clarity or for convenience of description, and thus the proportions or scales may not be strictly accurate.

In addition, in describing the present invention below, detailed descriptions of the configuration, for example, of known art, including prior art, may be omitted where it is determined that such descriptions would unnecessarily obscure the subject matter of the present invention.

Hereinafter, an apparatus and method for mass spectrometry using a nanostructure according to a preferred embodiment of the present invention will be described in detail with reference to the accompanying drawings.

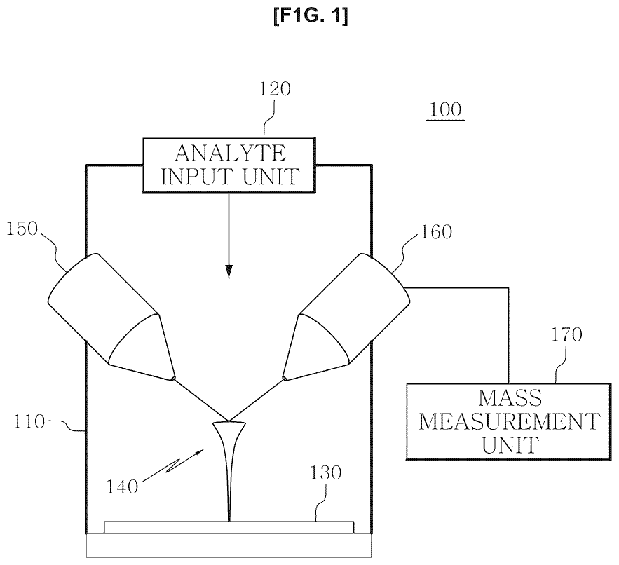

FIG. 1 is a view schematically illustrating the configuration of an apparatus for mass spectrometry using a nanostructure, according to an embodiment of the present invention.

As illustrated in FIG. 1, an apparatus 100 for mass spectrometry using a nanostructure according to the present invention may include a chamber 110, an analyte input unit 120, a substrate 130, an electron beam generator 150, a secondary electron detection unit 160, a mass measurement unit 170, and the like.

In this configuration, the chamber 110 may provide a space for performing mass spectrometry.

The chamber 110 may be implemented as an electron microscope chamber maintained in a vacuum state.

The analyte input unit 120 may input an analyte to be subject to mass measurement into the chamber 110.

Techniques for inputting an analyte into the chamber 110 may include an electrospray ionization (ESI) technique, in which a liquid solution of a solvent and an analyte mixed together is ionized by applying a high voltage, a freeze drying technique, in which a liquid solution of a solvent and an analyte mixed together is input into a chamber and then freeze dried, and the like, but are not limited thereto.

The substrate 130 is disposed inside the chamber 110, and at least one nanostructure 140 may be formed on top of the substrate 130, to which the analyte input by the analyte input unit 120 is adsorbed.

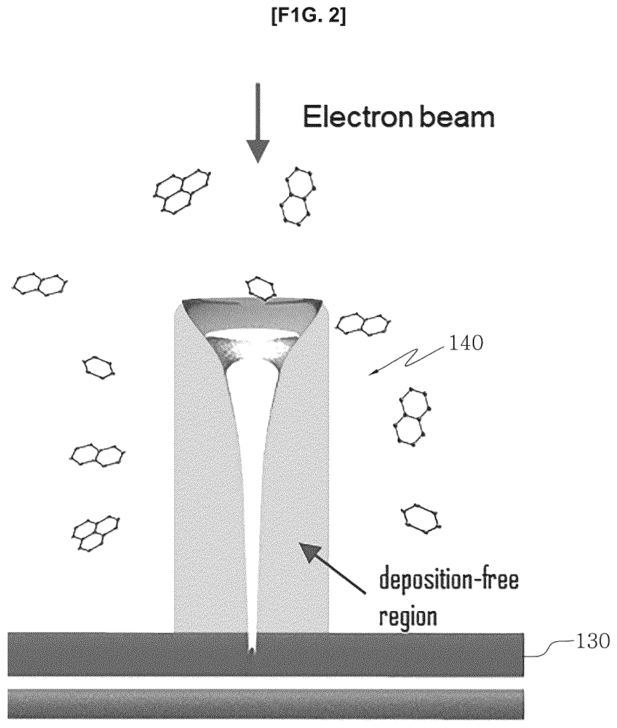

The nanostructure 140 formed on the substrate 130 may be formed as a tapered structure that tapers downward as illustrated in FIG. 2.

As described above, the nanostructure 140 formed as a tapered structure may have a portion of one end vertically inserted into and fixed to the substrate 130, and the other end formed to have a wider area than one end, and preferably have an upper portion formed to have a flat surface so that the analyte may be absorbed thereon.

As described above, since the nanostructure 140 is formed in a vertical form to the substrate 130, has an upper side formed wider than a lower side fixed to the substrate 130, and has an upper surface of the upper side formed flat, the analyte may be adsorbed only to the plateau area on the upper side, thereby facilitating frequency analysis depending on a change in mass of the analyte adsorbed to the plateau area on the upper side (the other end). Here, a diameter of the plateau area on the upper side (the other end) of the nanostructure 140 may be implemented as approximately 500 nm.

The nanostructure 140 with this structure is preferably implemented in a diamond material.

The reason for implementing the nanostructure 140 as a diamond in the embodiment of the present invention is that the quality factor (Q factor) of diamond falls on a quite high side.

Further, the Q value degrades as the structure gets smaller in nanoform. When the structure is implemented as a diamond, the diamond structure has the smallest degradation in Q value even though it gets smaller in nanoform.

Therefore, when the nanostructure 140 is implemented in diamond, the degradation in Q value is small even though the structure becomes smaller in nanoform, and thus a high Q value may be maintained.

In addition, when the nanostructure 140 is implemented in diamond material, it is not necessary to make the nanostructure 140 at low temperature, as the nanostructure 140 exhibits a high Q value even at room temperature.

In the embodiment of the present invention, the mass of the analyte is analyzed by measuring a change in resonance frequency due to a change in mass of the analyte adsorbed on the nanostructure 140. The higher the Q factor, the sharper the resonance property appears, resulting in better frequency selectivity.

As described above, while the embodiment of the present invention has been described with an example in which the nanostructure 140 is implemented in a diamond material, the present invention is not limited thereto.

The electron beam generator 150, under the control of a control unit (not illustrated), may irradiate the nanostructure 140 formed on the substrate 130 with an electron beam.

Specifically, the electron beam generator 150 may irradiate an edge of the nanostructure 140 formed on the substrate 130 with an electron beam.

When the electron beam generator 150 irradiates the edge of the nanostructure 140 formed on the substrate 130 with an electron beam, a portion of the nanostructure 140 becomes electrically charged, which creates an attraction with the substrate 130, causing mechanical vibration. Simultaneously, an interaction between the electron beam and the analyte adsorbed on the nanostructure 140 causes a secondary electron to be emitted from the analyte.

When the electron beam generator 150 irradiates the nanostructure 140 with an electron beam, the secondary electron detection unit 160 may detect a secondary electron signal emitted by the interaction of the electron beam with the nanostructure 140.

The secondary electron detection unit 160 described above may detect the secondary electron signal, and convert the detected secondary electron signal into an image signal to provide a three-dimensional image.

The mass measurement unit 170 may identify a vibrational state of the nanostructure 140 through frequency analysis of the secondary electron signal detected through the secondary electron detection unit 160, and measure the mass.

The control unit (not illustrated) may control an operation of the electron beam generator 150, the secondary electron detection unit 160, the mass measurement unit 170, and the like.

The control unit (not illustrated) may set an irradiation area of the electron beam emitted to the nanostructure 140, and then control the electron beam generator 150 on the basis of the set electron beam irradiation area.

In addition, the control unit (not illustrated) may reset an electron beam irradiation area on the basis of a frequency analysis result from the mass measurement unit 170.

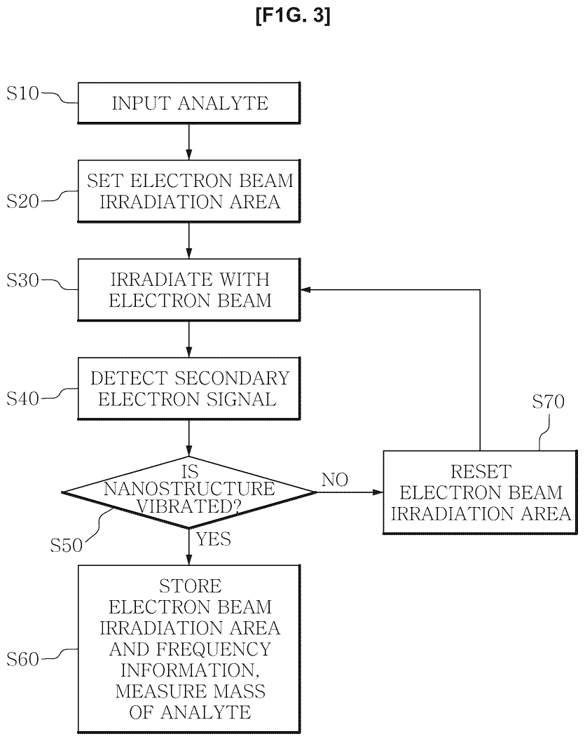

FIG. 3 is a processing view for describing a method of mass spectrometry using a nanostructure according to an embodiment of the present invention.

A method of mass spectrometry using a nanostructure according to the present invention may proceed in substantially the same configuration as the apparatus 100 for mass spectrometry using a nanostructure illustrated in FIG. 1. An embodiment of the present invention is described with an example in which a single nanostructure 140 is formed on the substrate 130.

First, in step S10, an analyte to be subjected to mass measurement may be input into the chamber 110.

Techniques for inputting an analyte into the chamber 110 in step S10 above may include an electrospray ionization (ESI) technique, a freeze drying technique, and the like, but are not limited thereto.

When the analyte is input into the chamber 110 through step S10 above, the input analyte is adsorbed to the plateau area of the nanostructure 140 formed in a tapered structure on the substrate 130.

Then, in step S20, an irradiation area of the electron beam emitted toward the nanostructure 140 to which the analyte input into the chamber 110 through step S10 above is adsorbed may be set.

In step S20 above, the electron beam irradiation area may be manually set by the analyst performing mass spectrometry, and the apparatus 100 for mass spectrometry may automatically set a random area.

When the electron beam irradiation area is set through step S20 above, in step S30, the nanostructure 140 may be irradiated with an electron beam on the basis of the electron beam irradiation area set in step S20 above.

When the nanostructure 140 is irradiated with an electron beam in step S30 above, a portion of the nanostructure 140 becomes electrically charged, which creates an attraction with the substrate 130, causing mechanical vibration. Simultaneously, an interaction between the electron beam and the analyte adsorbed on the nanostructure 140 causes a secondary electron to be emitted from the analyte.

Then, in step S40, the secondary electron signal emitted by the interaction of the electron beam emitted in step S30 above with the nanostructure 140 may be detected.

When the secondary electron signal is detected through step S40 above, in step S50, the secondary electron signal detected in step S40 above is subjected to a Fourier transform (FT) to perform a frequency analysis and identify whether the nanostructure 140 is vibrating.

When the nanostructure 140 is irradiated with an electron beam in step S30 above, the nanostructure 140 generates a mechanical vibration when an edge of the nanostructure 140 is irradiated with the electron beam.

When the nanostructure 140 is identified as vibrating as a result of the identification in step S50 above, information on the electron beam irradiation area set in step S20 above, and frequency information of the secondary electron signal detected in step S40 above may be stored. Meanwhile the mass of the analyte may be measured on the basis of a frequency analysis result (S60).

Meanwhile, when the nanostructure 140 is identified as not vibrating as a result of the identification in step S50 above, the electron beam irradiation area set in step S20 above may be moved, and an electron beam irradiation area may be reset (S70).

When an electron beam irradiation area is reset in step S70 above, an electron beam irradiation area may be reset in a way of moving the previously set electron beam irradiation area by a preset distance in a preset direction.

After an electron beam irradiation area is reset through step S70 above, the method may proceed to step S30 above to irradiate the nanostructure 140 with an electron beam on the basis of the electron beam irradiation area reset in step S70 above, and repeat the subsequent steps.

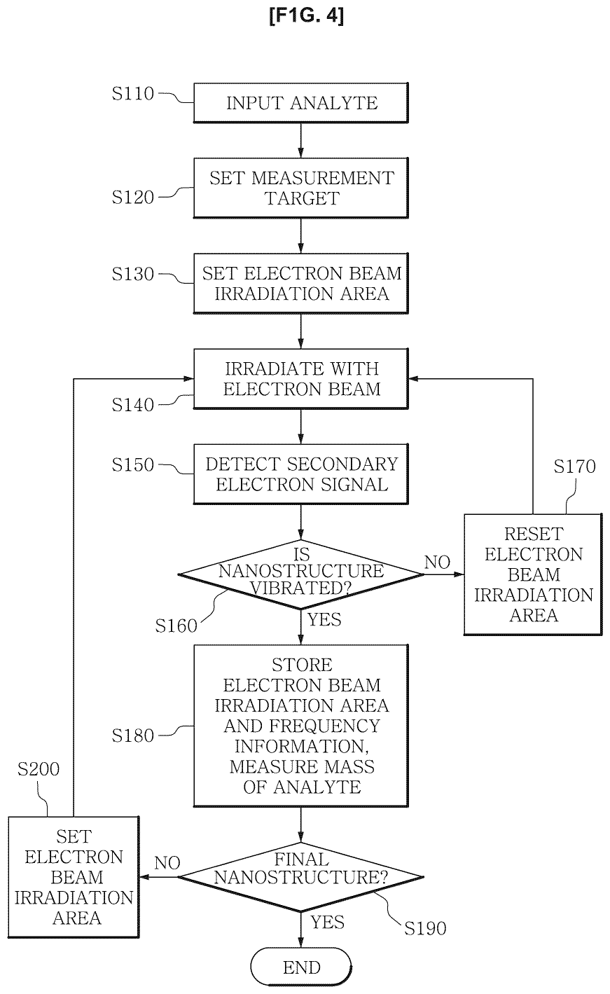

FIG. 4 is a processing view for describing a method of mass spectrometry using a nanostructure according to another embodiment of the present invention.

A method of mass spectrometry using a nanostructure according to another embodiment of the present invention may proceed in substantially the same configuration as the apparatus 100 for mass spectrometry using a nanostructure illustrated in FIG. 1. Another embodiment of the present invention is described with an example in which a plurality of nanostructures 140 is formed on the substrate 130.

First, in step S110, an analyte to be subjected to mass measurement may be input into the chamber 110.

When the analyte is input into the chamber 110 through step S110 above, the input analyte is adsorbed to the plateau area of the plurality of nanostructures 140 formed in a tapered structure on the substrate 130.

Then, in step S120, a measurement target may be set from among the plurality of nanostructures 140 to which the analyte input into the chamber 110 through step S110 above has been adsorbed.

In step S120 above, the measurement target may be manually set by the analyst performing mass spectrometry, and the apparatus 100 for mass spectrometry may automatically set a random nanostructure 140.

When the measurement target is set through the step S120 above, a sequence number may be given for each nanostructure 140, which is the measurement target.

Then, in step S130, an irradiation area of the electron beam emitted toward the nanostructure 140 of one of the measurement targets set in step S120 above may be set.

In step S130 above, an electron beam irradiation area of the nanostructure 140 given a sequence number 1 may be set according to the sequence number given to the nanostructure 140 to be measured.

Then, in step S140, the nanostructure 140 may be irradiated with an electron beam on the basis of the electron beam irradiation area set in step S130 above.

Then, in step S150, the secondary electron signal emitted from the analyte by the interaction of the electron beam emitted in step S140 above with the corresponding nanostructure 140 may be detected.

When the secondary electron signal is detected through step S150 above, in step S160, the secondary electron signal detected in step S150 above is subjected to a Fourier transform to perform a frequency analysis and identify whether the nanostructure 140 is vibrating.

When the corresponding nanostructure 140 is identified as vibrating as a result of the identification in step S160 above, information on the electron beam irradiation area set in step S130 above, and frequency information of the secondary electron signal detected in step S150 above may be stored. Meanwhile the mass of the analyte adsorbed to the corresponding nanostructure 140 may be measured on the basis of a frequency analysis result (S180).

Then, in step S190, it is determined whether the nanostructure 140 identified as vibrating through step S160 above is a final nanostructure among the nanostructures 140 to be measured that have been set in step S120 above.

When the corresponding nanostructure 140 is a final nanostructure as a result of the determination in step S190 above, mass spectrometry is terminated, and when the corresponding nanostructure 140 is not a final nanostructure, an electron beam irradiation area may be set for a next nanostructure (e.g., a nanostructure of sequence number 2) according to the sequence number (S200).

After an electron beam irradiation area is set for the next nanostructure 140 through step S200 above, the method may proceed to step S140 above to irradiate the next nanostructure 140 with an electron beam on the basis of the electron beam irradiation area set for the next nanostructure 140 in step S200 above, and repeat the subsequent steps.

Meanwhile, when the nanostructure 140 is identified as not vibrating as a result of the identification in step S160 above, the electron beam irradiation area set in step S130 above may be moved, and an electron beam irradiation area may be reset (S170).

After an electron beam irradiation area is reset through step S170 above, the method may proceed to step S140 above to irradiate the nanostructure 140 with an electron beam on the basis of the electron beam irradiation area reset in step S200 above, and repeat the subsequent steps.

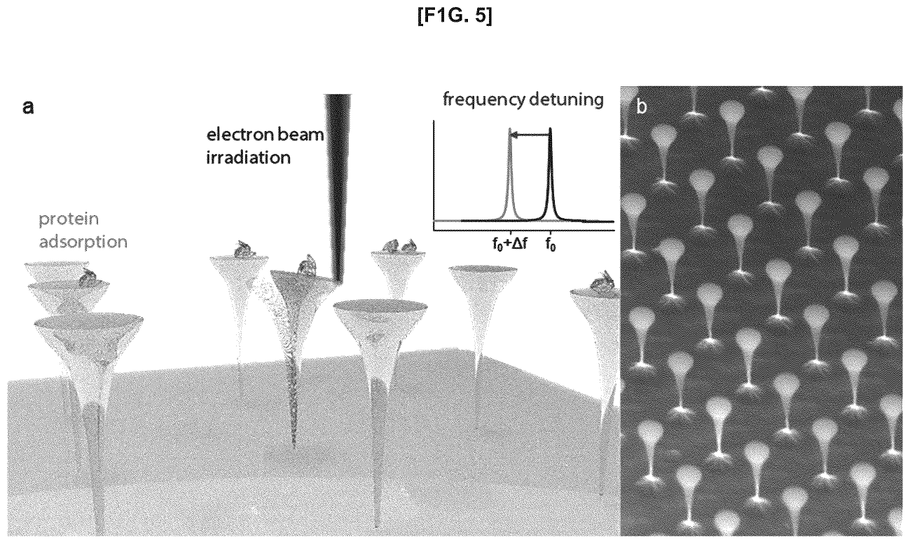

FIG. 5 is a view exemplarily illustrating a diamond nanostructure applicable to the present invention, and FIG. 5B is a view exemplarily illustrating an electron micrograph.

As described above, in the embodiment of the present invention, the mass is analyzed using the nanostructure 140, which is formed as a tapered structure tapering downward and is implemented in diamond material.

Specifically, the nanostructure 140 is electrically charged by the incident electron beam, which generates a mechanical vibration. Simultaneously, the interaction of the electron beam with the nanostructure 140 causes a secondary electron to be emitted from the analyte.

As described above, as the nanostructure 140 is irradiated with an electron beam, the secondary electron signal emitted from the analyte may be collected to measure the frequency component, and the mass may be measured by calculating a change in mass on the basis of a change in frequency.

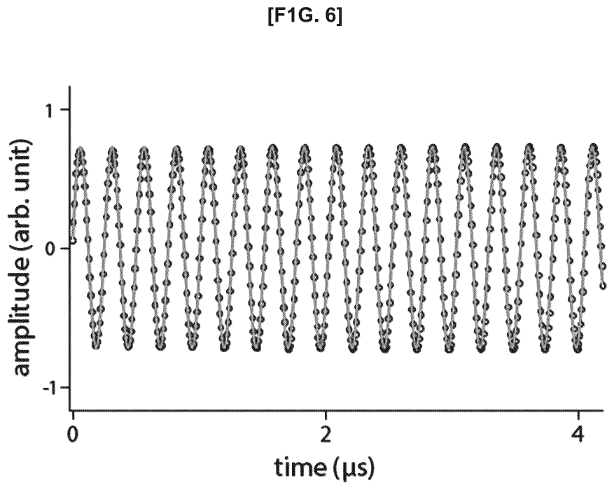

FIG. 6 is a view exemplarily illustrating a secondary electron signal detected, according to the present invention. As illustrated in FIG. 6, the detected secondary electron signal may be displayed on an oscilloscope.

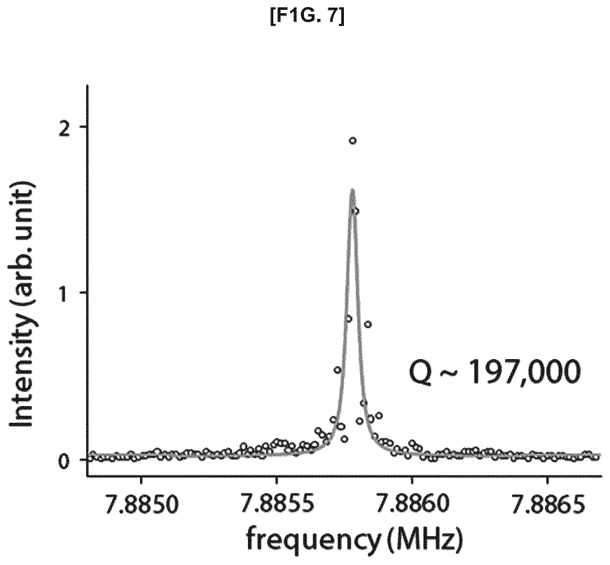

FIG. 7 is a view exemplarily illustrating a frequency spectrum obtained by Fourier transforming a secondary electron signal detected, according to the present invention. As the nanostructure 140 is implemented in a diamond material with a large Q factor, it is possible to identify a sharp resonance property.

Therefore, it becomes easier to measure a change in resonance frequency due to a change in mass.

The apparatus 100 for mass spectrometry using a nanostructure according to the present invention is capable of performing mass measurement at room temperature on the basis of these properties.

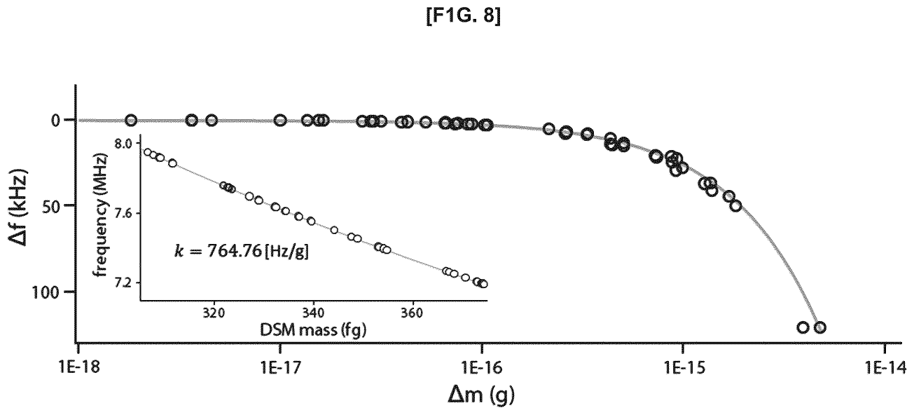

FIG. 8 is a view exemplarily illustrating an experimental result of performing a mass measurement, according to the present invention.

Even if the gas inside the electron microscope chamber is discharged to make a space inside the chamber in a vacuum state, carbon will remain inside the chamber.

When the nanostructure 140 is irradiated with an electron beam in a state where the carbon remains inside the chamber in a vacuum state, the collision of the electron beam with the carbon causes the carbon to be deposited on the nanostructure 140, and as the time for irradiation with an electron beam increases, the number of carbon deposited on the nanostructure 140 increases.

Accordingly, in this experiment, the process of irradiating the nanostructure 140 with an electron beam to deposit carbon on the nanostructure 140, measuring a change in resonance frequency accordingly, again irradiating the nanostructure 140 with an electron beam to deposit carbon on the nanostructure 140, and measuring a change in resonance frequency accordingly was repeated, and the data obtained through this experiment can be seen through FIG. 8.

In FIG. 8, Δm indicates an amount of analyte (carbon) deposited on the nanostructure 140 by adjusting the irradiation time of an electron beam, Δf and indicates an amount of change in resonance frequency before and after depending on the amount of analyte (carbon) deposited on the nanostructure 140. Through this experiment, it can be seen that the resonance frequency changes when the amount of analyte deposited on the nanostructure 140 changes.

In addition, through this experiment, in which carbon was deposited on the nanostructure 140 and the change in resonant frequency was measured, it can be seen that the mass measurement range may be extended from several MDa to several GDa.

In addition, the measurement accuracy will not degrade as the mass of analyte to be measured increases.

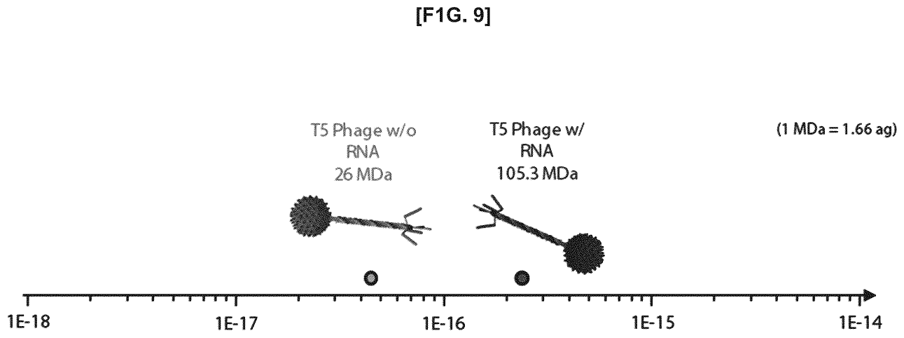

FIG. 9 is a view exemplarily illustrating mass of a T5 phage among bacteriophages.

In FIG. 9, the T5 phage on the left is infected with a bacterium and is in a state without RNA in the head, and the T5 phage on the right is in a state with RNA in the head. Through the experiments described above, since the apparatus 100 for mass spectrometry using a nanostructure according to the present invention has a resolution corresponding to 1 MDa, it is possible to measure a mass difference depending on the presence and absence of RNA inside the virus.

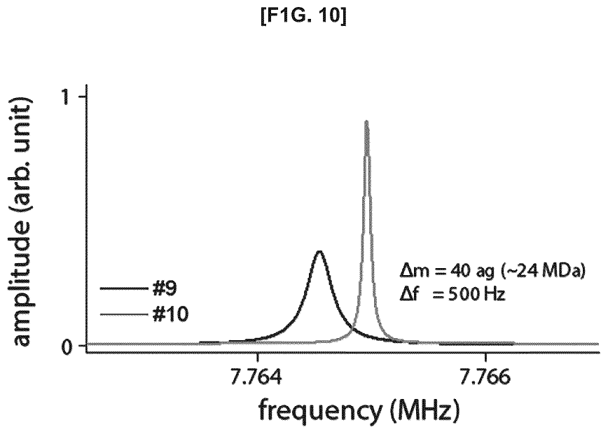

FIG. 10 is a view exemplarily illustrating a demonstrative graph to show how Δf is determined in the present invention. The resonance frequency before the analyte is adsorbed to the nanostructure 140 of a diamond material may be measured, and the resonance frequency after the analyte is adsorbed to the nanostructure 140 may be measured, and a difference thereof may be determined as Δf. Further, it can be seen that the mass of analyte adsorbed on the nanostructure 140 is approximately 40 ag by calculating a change in mass on the basis of a change in resonance frequency.

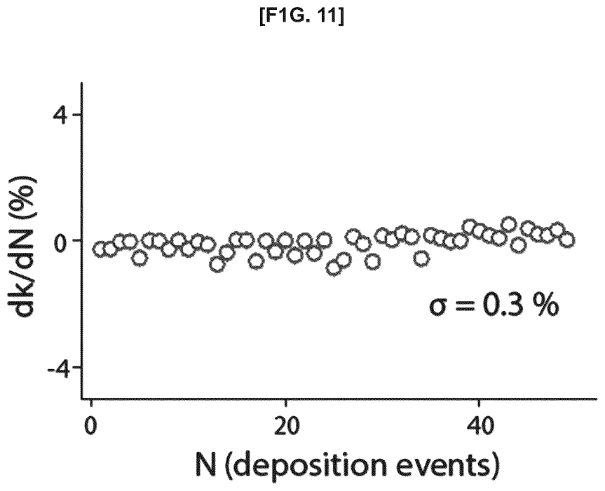

FIG. 11 is a view exemplarily illustrating a spring constant (elastic modulus) for a nanostructure of a diamond material applicable to the present invention. As in the previous experiment, even if the process of irradiating the nanostructure 140 with an electron beam, depositing carbon on the nanostructure 140, measuring a change in resonance frequency accordingly, again irradiating the nanostructure 140 with an electron beam, depositing carbon on the nanostructure 140, and measuring a change in resonance frequency accordingly, is repeatedly performed, it can be seen that the value of spring constant (elastic modulus) of the nanostructure remains constant with linearity without being affected by the number of measurements.

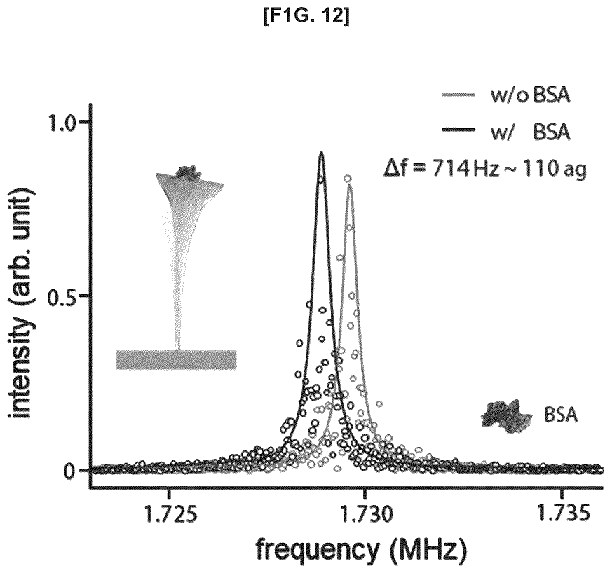

FIG. 12 is a view exemplarily illustrating a result of measuring mass of a protein molecule according to the present invention. After the bovine serum albumin (BSA) was adsorbed to the nanostructure 140, an amount of change in resonance frequency was measured accordingly, and a change in mass was calculated on the basis of the measured amount of change in resonance frequency. As a result, it was possible to measure the mass equivalent to approximately 1000 bovine serum albumin.

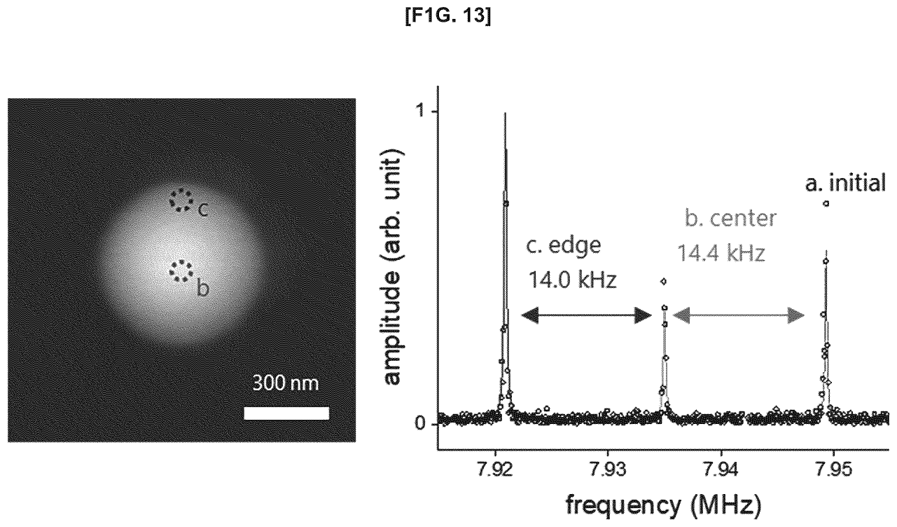

FIG. 13 is a view exemplarily illustrating measurement frequencies depending on a position of an analyte adsorbed in a nanostructure of a diamond material applicable to the present invention. After the same amount of analyte is adsorbed to the center and edge of the nanostructure 140, respectively, and an amount of change in frequency is measured. As a result, it can be seen that a difference of approximately 2 to 3% occurs.

In this case, the difference may increase as the mass of analyte adsorbed to the nanostructure 140 increases.

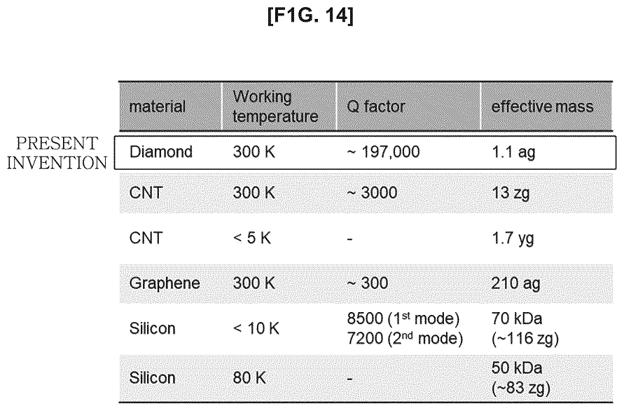

FIG. 14 is a view exemplarily illustrating a performance comparison result of the present invention and the prior arts. It can be seen that the performance of the present invention has increased. That is, the present invention enables performing mass measurement at room temperature, has a high Q factor, and is capable of measuring mass on the order of 1.1 ag.

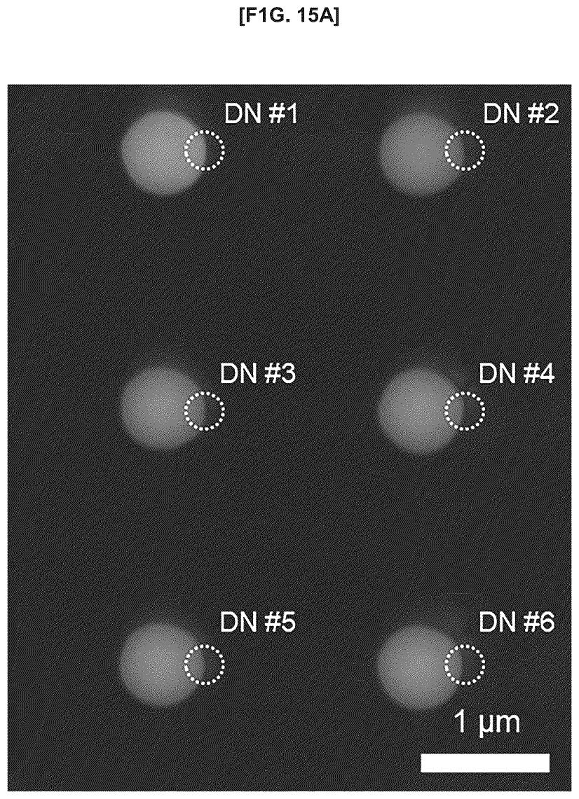

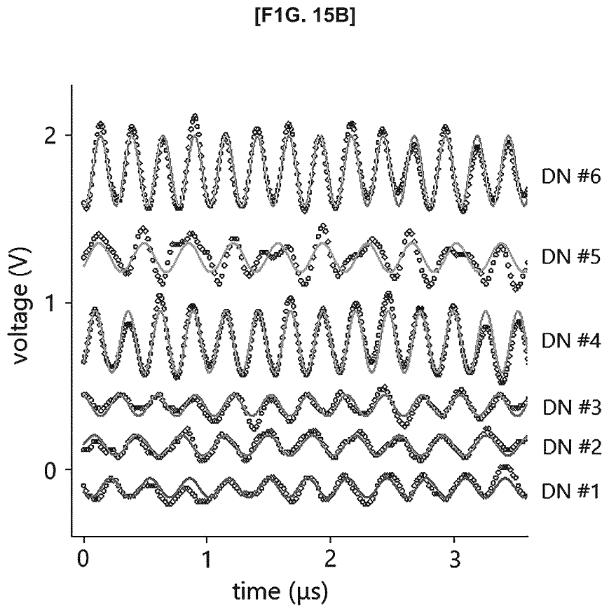

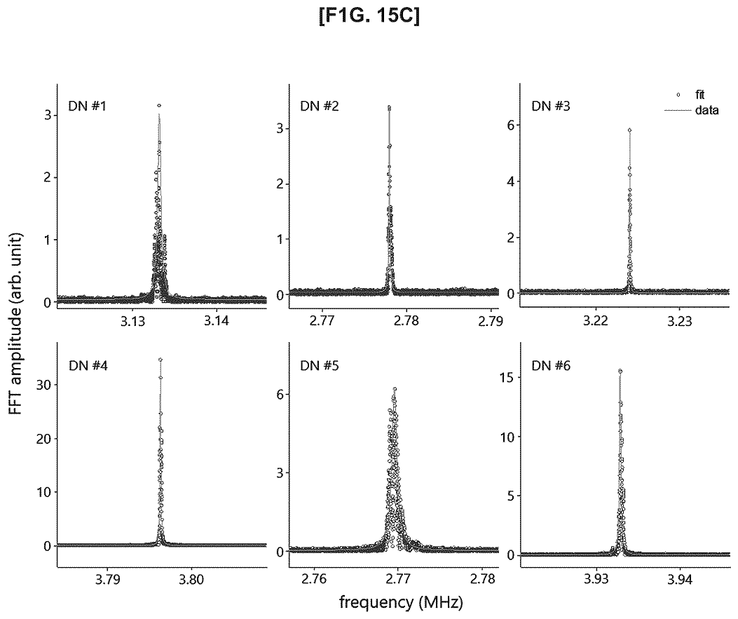

FIGS. 15A to 15C are a view exemplarily illustrating a case in which mass spectrometry is performed by sequentially irradiating a plurality of nanostructures with an electron beam, according to the present invention. After an electron beam irradiation area is set for each of the plurality of nanostructures (see FIG. 15A), the corresponding irradiation area is sequentially irradiated with an electron beam on the basis of a preset irradiation time. The secondary electron signal emitted accordingly is collected and the signal is divided in accordance with the number of nanostructures 140 (see FIG. 15B). Then, when frequency analysis is performed on each secondary electron signal by Fourier transform (see FIG. 15C), it is possible to perform mass spectrometry by measuring a change in frequency for multiple analytes at once.

While the description above describes various preferred embodiments of the present invention with some examples, it should be understood that the description of the various embodiments described in this “detailed description of the invention” section is merely illustrative, and those skilled in the art to which the present invention belong can modify the present invention from the above description to perform various other embodiments, or to perform embodiments equivalent to the present invention.

In addition, it should be understood that the present invention are not limited by the description above, as the present invention may be implemented in a variety of other forms, and that the above description is provided only to make the disclosure of the present invention complete and to inform those skilled in the art to which the present invention belong of the scope of the present invention, and that the present invention are only defined by the respective claims of the claims.

### DESCRIPTION OF REFERENCE NUMERALS

110. Chamber,
120. Analyte input unit,
130. Substrate,
140. Nanostructure
150. Electron beam generator,
160. Secondary electron detection unit,
170. Mass measurement unit

What is claimed is:

1. An apparatus for mass spectrometry using a nanostructure comprising:
a chamber providing a space in which mass spectrometry is performed;
an analyte input unit configured to input an analyte into the chamber;
a substrate disposed inside the chamber and having at least one nanostructure formed thereon, to which the analyte input by the analyte input unit is adsorbed;
an electron beam generator configured to irradiate the nanostructure with an electron beam;
a secondary electron detection unit configured to detect a secondary electron signal emitted by an interaction of the electron beam with the nanostructure; and
a mass measurement unit configured to identify a vibrational state of the nanostructure and measure mass of the nanostructure through frequency analysis of the detected secondary electron signal.

2. The apparatus of claim 1, wherein the nanostructure formed in the substrate is formed in a tapered structure that tapers downward.

3. The apparatus of claim 2, wherein the nanostructure formed in the substrate is implemented in a diamond material.

4. A method of mass spectrometry using a nanostructure, the method comprising:
inputting an analyte into a chamber;
setting an electron beam irradiation area for a nanostructure to which the input analyte is adsorbed;
irradiating the set electron beam irradiation area with an electron beam;
detecting a secondary electron signal emitted by an interaction of the electron beam with the nanostructure;
identifying a vibrational state of the nanostructure through frequency analysis of the detected secondary electron signal; and
recording frequency information on the detected secondary electron signal and the electron beam irradiation area when the vibrational state of the nanostructure is identified as a result of the identification, and measuring mass of the analyte on the basis of a frequency analysis result.

5. The method of claim 4, further comprising:
resetting an electron beam irradiation area, when the vibrational state of the nanostructure is not identified as a result of the identification, then proceeding to the step of irradiation with an electron beam, irradiating the reset electron beam irradiation area with an electron beam, and repeating the subsequent steps.

6. A method of mass spectrometry using a nanostructure, the method comprising:
inputting an analyte into a chamber;
setting nanostructures to be measured from a nanostructure array in which the inputted analyte is adsorbed;
setting an electron beam irradiation area for one nanostructure of the set nanostructures to be measured;
irradiating the set electron beam irradiation area with an electron beam;
detecting a secondary electron signal emitted by an interaction of the electron beam with the nanostructure;
identifying a vibrational state of the nanostructure through frequency analysis of the detected secondary electron signal;
recording frequency information of the detected secondary electron signal and an electron beam irradiation area, when the vibrational state of the nanostructure is identified as a result of the identification, and measuring mass of the analyte adsorbed to the nanostructure on the basis of a frequency analysis result;
determining whether the nanostructure is a final nanostructure among the nanostructures to be measured; and
terminating the mass spectrometry when the nanostructure is the final nanostructure as a result of the determination, setting an electron beam irradiation area for a next nanostructure when the nanostructure is not the final nanostructure, then proceeding to the step of irradiation with an electron beam, irradiating the set electron beam irradiation area with an electron beam, and repeating the subsequent steps.

7. The method of claim 6, further comprising:
resetting an electron beam irradiation area, when the vibrational state of the nanostructure is not identified as a result of the identification, then proceeding to the step of irradiation with an electron beam, irradiating the reset electron beam irradiation area with an electron beam, and repeating the subsequent steps.
